(19) United States
(12) Patent Application Publication
(10) Pub. No.: US 2014/0186619 A1
(43) Pub. Date: Jul. 3, 2014

(54) COATED ARTICLE AND METHOD FOR MAKING THE SAME

(71) Applicants: SHENZHEN FUTAIHONG PRECISION INDUSTRY, Shenzhen (CN); FIH (HONG KONG) LIMITED, Kowloon (HK)

(72) Inventors: CHUN-JIE ZHANG, Shenzhen (CN); XU LIU, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/866,398

(22) Filed: Apr. 19, 2013

(30) Foreign Application Priority Data
Dec. 29, 2012 (CN) 201210587822.5

(51) Int. Cl. C09D 5/00

(52) U.S. Cl. CPC C09D 5/00
USPC 428/336; 427/255.6; 524/439; 524/593; 427/255.395; 427/534; 427/595; 428/460

(57) ABSTRACT

A coated article includes a substrate and an anti-fingerprint film formed on the substrate. The anti-fingerprint film is a mixture layer of tin and polyformaldehyde, a mixture layer of indium and polyformaldehyde, or a polyformaldehyde layer. The anti-fingerprint film has an excellent abrasion resistance. A method for making the coated article is also described.

### BACKGROUND

1. Technical Field

The present disclosure relates to coated articles, especially to a coated article having an anti-fingerprinting property and a method for making the coated article.

2. Description of Related Art

Many electronic device housings are coated with anti-fingerprint films. The anti-fingerprint film is commonly painted on the housing as a paint containing organic anti-fingerprint substances. However, the printed film has a poor abrasion resistance.

Therefore, there is room for improvement within the art.

### BRIEF DESCRIPTION OF THE DRAWING

Many aspects of the disclosure can be better understood with reference to the following figure. The components in the figure are not necessarily drawn to scale, the emphasis instead being placed upon clearly illustrating the principles of the disclosure. Moreover, in the drawings like reference numerals designate corresponding parts throughout the several views.

FIG. 1 is a cross-sectional view of a coated article in accordance with an exemplary embodiment.

FIG. 2 is a schematic view of a vacuum vapor deposition device in accordance with an exemplary embodiment.

### DETAILED DESCRIPTION

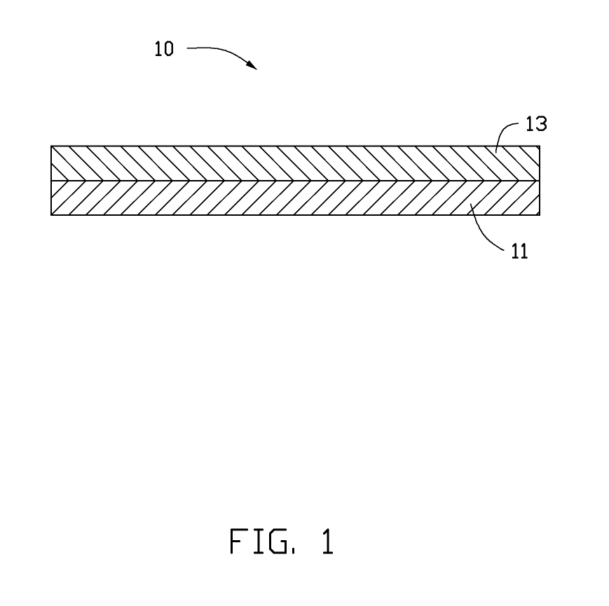

FIG. 1 shows a coated article 10 according to an exemplary embodiment. The coated article 10 includes a substrate 11, and an anti-fingerprint film 13 directly formed on a surface of the substrate 11. The coated article 10 may be a housing of an electronic device, any ornament, or a housing of a clock.

The substrate 11 may be made of aluminum, aluminum alloy, or stainless steel.

The anti-fingerprint film 13 has a thickness of about 10 micrometers (pm) to about 20 μm. The anti-fingerprint film 13 is formed by vacuum vapor deposition. The anti-fingerprint film 13 may be a mixture layer of tin and polyformaldehyde, or a mixture layer of indium and polyformaldehyde. In the mixture layer of tin and polyformaldehyde, the tin has a mass percentage of about 30% to about 50%, the polyformaldehyde has a mass percentage of about 50% to about 70%. In the mixture layer of indium and polyformaldehyde, the indium has a mass percentage of about 30% to about 50%, the polyformaldehyde has a mass percentage of about 50% to about 70%. The mixture layer of tin and polyformaldehyde presents a white color, the mixture layer of indium and polyformaldehyde presents an off-white color. Alternatively, the anti-fingerprint film 13 may be a polyformaldehyde layer presenting a white color.

A method for making the coated article 10 may include the following steps.

The substrate 11 is provided, and then cleaned in an ultrasonic cleaning device (not shown) which is filled with absolute ethanol for about 25 minutes (min) to about 35 min.

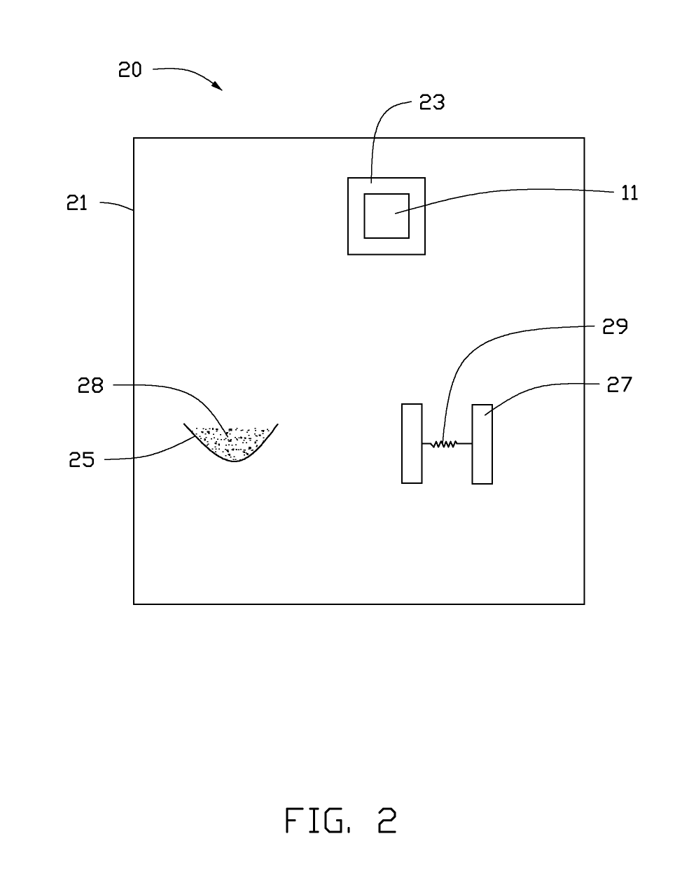

Referring to FIG. 2, a vacuum vapor deposition device 20 is provided. The device 20 includes a chamber 21, a fixing element 23, a crucible 25, and two electrodes 27. The fixing element 23, the crucible 25, and the electrodes 27 are all positioned in the chamber 21.

The substrate 11 is fastened to the fixing element 23. Polyformaldehyde particles 28 having a mass of about 300 g to about 500 g is provided and filled in the crucible 25. A wire 29 is provided to connect the two electrodes 27. The wire 29 is made of tin of indium, and has a diameter of about 0.5 mm to about 1.0 mm. The chamber 21 is evacuated to about 8.0×10⁻³ Pa, then argon gas is used as a working gas and is injected into the chamber 21 at a flow rate of about 500 standard-state cubic centimeters per minute (sccm) to about 800 sccm to plasma clean the substrate 11. Plasma cleaning the substrate 11 may take about 15 min to about 20 min. The plasma cleaning process enhances the bond between the substrate 11 and the anti-fingerprint film 13.

The crucible 25 is heated to an internal temperature of about 190° C.-230° C. under a heating rate of about 100° C./min-120° C./min. At this time, the polyformaldehyde particles 28 begin to melt. When the crucible 25 is heated to an internal temperature of about 400° C.-410° C., the heating rate is changed to about 0.5° C./min-0.8° C./min. At this time, the molten polyformaldehyde particles 28 begin to volatilize and deposit on the substrate 11. Simultaneously, a voltage of about 220 V is applied to the electrodes 27 to heat the wire 29, allowing the wire 29 to volatilize and deposit on the substrate 11 together with the volatilized polyformaldehyde to form the anti-fingerprint film 13. The depositing the anti-fingerprint film 13 may last 15 min to about 25 min.

Liquid nitrogen is injected into the chamber 21 at a flow rate of about 600 sccm to about 800 sccm to cool the anti-fingerprint film 13 for about 5 min to about 6 min. Comparing to the polyformaldehyde, the tin or indium in the anti-fingerprint film 13 can be cooled more quickly. So, when the tin or indium in the anti-fingerprint film 13 has been completely cooled, the polyformaldehyde may still have molten parts. Therefore, liquid nitrogen is continued to inject into the chamber 21 to cool the molten polyformaldehyde, at a flow rate of about 300 sccm to about 500 sccm for about 9 min to about 10 min.

It is to be understood that, when the anti-fingerprint film 13 is a polyformaldehyde layer, the wire 29 is not needed to be provided during the vacuum vapor deposition.

Specific examples of making the coated article 10 are described as following. The processes of plasma cleaning the substrate 11 and vacuum vapor depositing the anti-fingerprint film 13 in the specific examples is substantially the same as described above and the specific examples mainly emphasize the different process parameters of making the coated article 10.

### EXAMPLE 1

The substrate 11 was made of aluminum. The substrate 11 was cleaned in the ultrasonic cleaning device filled with absolute ethanol for 25 min.

Polyformaldehyde particles 28 having a mass of 300 g was provided and filled in the crucible 25. A wire 29 made of tin was provided to connect the two electrodes 27.

During the plasma cleaning of the substrate 11: the argon gas had a flow rate of 500 sccm, plasma cleaning the substrate 11 took 15 min.

In vacuum vapor depositing the anti-fingerprint film 13: the crucible 25 was heated to an internal temperature of 400° C. under a heating rate of 100° C./min first. Then the crucible 25 was continued heated under a heating rate of 0.8° C./min. Simultaneously, a voltage of about 220 V is applied to the electrodes 27 to heat the wire 29. Depositing the anti-fingerprint film 13 lasted 15 min. The anti-fingerprint film 13 had a thickness of about 10 μm. The anti-fingerprint film 13 was a mixture layer of tin and polyformaldehyde, wherein the tin had a mass percentage of 30%, the polyformaldehyde had a mass percentage of 70%.

In cooling the anti-fingerprint film 13: liquid nitrogen was injected into the chamber 21 at a flow rate of 600 sccm for 5 min first. Then liquid nitrogen was continued to inject into the chamber 21 at a flow rate of 300 sccm for 10 min.

### EXAMPLE 2

The substrate 11 was made of stainless steel. The substrate 11 was cleaned in the ultrasonic cleaning device filled with absolute ethanol for 30 min.

Polyformaldehyde particles 28 having a mass of 400 g was provided and filled in the crucible 25. A wire 29 made of indium was provided to connect the two electrodes 27.

During the plasma cleaning of the substrate 11: the argon gas had a flow rate of 700 sccm, plasma cleaning the substrate 11 took 20 min.

In vacuum vapor depositing the anti-fingerprint film 13: the crucible 25 was heated to an internal temperature of 405° C. under a heating rate of 110° C./min first. Then the crucible 25 was continued heated under a heating rate of 0.6° C./min. Simultaneously, a voltage of about 220 V is applied to the electrodes 27 to heat the wire 29. Depositing the anti-fingerprint film 13 lasted 20 min. The anti-fingerprint film 13 had a thickness of about 15 μm. The anti-fingerprint film 13 was a mixture layer of indium and polyformaldehyde, wherein the indium had a mass percentage of 35%, the polyformaldehyde had a mass percentage of 65%.

In cooling the anti-fingerprint film 13: liquid nitrogen was injected into the chamber 21 at a flow rate of 700 sccm for 6 min first. Then liquid nitrogen was continued to inject into the chamber 21 at a flow rate of 400 sccm for 10 min.

### EXAMPLE 3

The substrate 11 was made of stainless steel. The substrate 11 was cleaned in the ultrasonic cleaning device filled with absolute ethanol for 35 min.

Polyformaldehyde particles 28 having a mass of 500 g was provided and filled in the crucible 25.

During the plasma cleaning of the substrate 11: the argon gas had a flow rate of 700 sccm, plasma cleaning the substrate 11 took 15 min.

In vacuum vapor depositing the anti-fingerprint film 13: the crucible 25 was heated to an internal temperature of 410° C. under a heating rate of 120° C./min first. Then the crucible 25 was continued heated under a heating rate of 0.5° C./min. Depositing the anti-fingerprint film 13 lasted 25 min. The anti-fingerprint film 13 had a thickness of about 20 μm. The anti-fingerprint film 13 was a polyformaldehyde layer.

In cooling the anti-fingerprint film 13: liquid nitrogen was injected into the chamber 21 at a flow rate of 800 sccm for 6 min.

The coated articles 10 of the examples have been tested using a Vickers hardness tester (not shown). The tests indicated that the coated articles 10 had an average Vickers hardness of about 600 HV to about 750 HV. While the substrate 11 has only a Vickers hardness of about 250 HV to about 300 HV. Therefore, the anti-fingerprint film 13 has an excellent abrasion resistance.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A coated article, comprising:
a substrate; and
an anti-fingerprint film disposed on the substrate;
wherein the anti-fingerprint film is a mixture layer of tin and polyformaldehyde, a mixture layer of indium and polyformaldehyde, or a polyformaldehyde layer.

2. The coated article as claimed in claim 1, wherein when the anti-fingerprint film is a mixture layer of tin and polyformaldehyde, the tin has a mass percentage of about 30% to about 50%, the polyformaldehyde has a mass percentage of about 50% to about 70%.

3. The coated article as claimed in claim 1, wherein when the anti-fingerprint film is a mixture layer of indium and polyformaldehyde, the indium has a mass percentage of about 30% to about 50%, the polyformaldehyde has a mass percentage of about 50% to about 70%.

4. The coated article as claimed in claim 1, wherein the anti-fingerprint film has a thickness of about 10 μm to about 20 μm.

5. The coated article as claimed in claim 1, wherein the substrate is made of aluminum, aluminum alloy, or stainless steel.

6. The coated article as claimed in claim 1, wherein the coated article has a Vickers hardness of about 600 HV to about 750 HV.

7. A method for making a coated article, comprising:
providing a substrate;
forming an anti-fingerprint film on the substrate by vacuum vapor depositing, the anti-fingerprint film being a mixture layer of tin and polyformaldehyde, a mixture layer of indium and polyformaldehyde, or a polyformaldehyde layer.

8. The method as claimed in claim 7, wherein the vacuum vapor depositing is carried out in a vacuum vapor deposition device which comprises a chamber, a fixing element, a crucible, and two electrodes, the fixing element, crucible, and electrodes are all positioned in the chamber.

9. The method as claimed in claim 8, wherein before the vacuum vapor depositing, the substrate is fastened on the fixing element, the crucible is filled with polyformaldehyde particles, a wire made of tin or indium is provided to connect the two electrodes.

10. The method as claimed in claim 9, wherein during the vacuum vapor depositing, the crucible is heated to an internal temperature of about 190° C. to about 230° C. under a heating rate of about 100° C./min to about 120° C./min to allow the polyformaldehyde particles beginning to melt; wherein when the crucible is heated to an internal temperature of about 400° C. to about 410° C., the heating rate is changed to about 0.5° C./min to about 0.8° C./min, the molten polyformaldehyde particles begin to volatilize and deposit on the substrate to form the anti-fingerprint film.

11. The method as claimed in claim 10, wherein during the vacuum vapor depositing, a voltage of about 220 V is applied to the electrodes to heat the wire, allowing the wire to volatilize and deposit on the substrate together with the volatilized polyformaldehyde to form the anti-fingerprint film.

12. The method as claimed in claim 11, wherein the vacuum vapor depositing lasts about 15 min to about 25 min.

13. The method as claimed in claim 8, further comprising a step of cooling the anti-fingerprint film using liquid nitrogen after forming the anti-fingerprint film, the cooling process is carried out by injecting the liquid nitrogen into the chamber at a flow rate of about 600 sccm to about 800 sccm for about 5 min to about 6 min first, then the liquid nitrogen is continued to inject into the chamber at a flow rate of about 300 sccm to about 500 sccm for about 9 min to about 10 min.

14. The method as claimed in claim 8, further comprising a step of plasma cleaning the substrate using argon gas before forming the anti-fingerprint film, the chamber is evacuated to about 8.0×10⁻³ Pa, then the argon gas is injected into the chamber at a flow rate of about 500 sccm to about 800 sccm for about 15 min to about 20 min.
